(19) United States
(12) Patent Application Publication
(10) Pub. No.: US 2006/0198262 A1
(43) Pub. Date: Sep. 7, 2006

(54) Optical recording apparatus and optical recording method controlling laser power for disc overwriting

(75) Inventor: Koichi Urabe, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/345,171

(22) Filed: Feb. 1, 2006

(30) Foreign Application Priority Data
Mar. 7, 2005 (JP) 2005-062572

(51) Int. Cl. G11B 7/12

(52) U.S. Cl. 369/47.53

(57) ABSTRACT

An optical recording apparatus performs an OPC operation with a designated target modulation. A reproduction signal detecting circuit measures, in response to the OPC operation, jitter, amplitude of the reproduction signal and the like. An asymmetry detecting circuit calculates an asymmetry value of the optical disc from the measurements. An RAM temporarily stores the measured reproduction information. A laser power correcting circuit evaluates the calculated asymmetry value, and increases/decreases setting of the target modulation, through a laser power setting circuit. When the asymmetry value comes close to 0, a laser driving circuit performs an overwriting operation (DOW: Direct Over Write) with the current asymmetry value.

### BACKGROUND OF THE INVENTION

1. Field of the Invention

The present invention relates to an optical recording apparatus and an optical recording method. More specifically, the present invention relates to an optical recording apparatus and an optical recording method that control laser power when a disc is overwritten.

2. Description of the Background Art

Various types of optical recording apparatuses for recording data by irradiating a recording medium such as a disc with a laser beam have been implemented. Examples of the recording medium used for an optical recording apparatus include a CD (Compact Disc) and a DVD (Digital Versatile Disc). In the optical recording apparatus, data is recorded by irradiating a track on the disc with a laser beam modulated in accordance with the data to be recorded. As a method of data recording, a phase-change technology, for example, has been known.

In the phase-change type optical disc, the power of laser beam directed to the optical disc has a strong influence on data accuracy when the data is overwritten. If the power of laser beam were too weak, the data that has been written would be left un-erased. On the contrary, if the power of laser beam were too strong, cross-erasure of a neighboring track would result.

Therefore, in the phase-change type optical disc, generally, optimum condition values for laser beam irradiation are recorded in advance in a read-only area (control track) provided on an innermost or outermost circumference. At the time of data recording, the optical recording apparatus sets the power of laser beam to the optimum value based on the optimum condition values for laser beam irradiation recorded in advance.

Ever increasing capacity and ever higher density of rewritable optical discs, however, come to require shorter wavelength of laser beams and higher NA (Numerical Aperture) of objective lens. Consequently, in the optical recording apparatus, laser power control with higher accuracy becomes necessary. Further, there is a demand for laser power control that also addresses environmental variations on the optical disc and characteristics particular to each optical disc apparatus.

As described above, in the optical recording apparatus, when data is recorded with the laser beam, the recording power, erasing power and the like of the laser beam must be set to appropriate values. For this purpose, typically, an operation for determining optimum laser power, referred to as OPC (Optimum Power Control) is performed in the optical recording apparatus. In the OPC operation, a trial area (test area) prepared on the disc is irradiated with the laser beam, with varying laser power. Through this operation, the optical recording apparatus monitors quality (jitter level and the like) of the information reproduced from the trial area.

By the OPC operation as such, the optical recording apparatus realizes a recording operation with the optimum laser power. From the foregoing, it is naturally understood that the optimum laser power determined by the OPC operation should be as accurate as possible. The quality of reproduced signal, however, can not always be monitored accurately, dependent on the data contents written for trial, influence of cross-talk between neighboring tracks at the time of reproduction of the portion written for trial, and so on. In such a case, the laser power found through the OPC operation is not necessarily optimal.

In a conventional method of optical recording, the laser beam power is controlled using three values, that is, peak power, erasure power and bias power, within the range of the minimum linear speed to the maximum linear speed. When a mark is formed, the peak power and the bias power are applied alternately as pulses. In the optical recording method, when the time of pulse application is changed continuously between a time period proportional to a prescribed window width and a fixed time period, the peak power start time at the leading part of the pulse is adapted to be proportional to the prescribed window width mentioned above and the constant of proportionality is changed continuously at every linear speed (see, for example, Japanese Patent Laying-Open No. 2004-199784).

In a conventional optical disc apparatus, among three recorded tracks in a trial writing area of an optical disc, the maximum laser power that can avoid cross-erasure is obtained based on amplitude ratio between signals reproduced from the second and the third tracks. At the same time, in the optical disc apparatus, the minimum laser power that can avoid insufficient erasure is obtained from the asymmetry value generated by the deviation of the center of the amplitude between the maximum recording mark and the minimum recording mark of the reproduction signal on the third recorded track (see, for example, Japanese Patent Laying-Open No. 2002-342930).

In a conventional recording apparatus, recording and reproducing operations by a recording head are performed on a trial writing area of a recording medium while varying the laser power, and the optimum laser power is determined from the reproduction information. In the recording apparatus, at the time of a recording operation on the trial writing area, a necessary pattern is selectively generated among unit data patterns, random data patterns and non-data patterns, by the unit of one track period of the recording medium (see, for example, Japanese Patent Laying-Open No. 2000-251257).

In the conventional optical recording apparatus, as one measure for controlling the laser power found through the OPC operation with high accuracy, the information to be reproduced from the optical disc is adjusted to be within a prescribed specification. Here, BLER (Block Error Rate) when information is overwritten on the optical disc tends to increase, degrading the recording characteristic.

### SUMMARY OF THE INVENTION

An object of the present invention is to provide an optical recording apparatus and an optical recording method that can improve recording characteristic at the time of disc overwriting.

The present invention provides an optical recording apparatus performing an OPC operation with controlled laser power and recording information on a recording medium, including: a reproduction signal detecting circuit measuring, in response to the OPC operation, reproduction information included in a signal reproduced from the recording medium; an asymmetry detecting circuit calculating an asymmetry value of the recording medium from the reproduction information; a laser power correcting circuit evaluating the asymmetry value and determining target modulation of the OPC operation in accordance with the evaluation; a laser power setting circuit changing the laser power, in accordance with the target modulation determined by the laser power correcting circuit; and a laser driving circuit performing an overwriting operation on the recording medium, with the laser power attained when the asymmetry value comes close to 0.

Preferably, the laser power correcting circuit increases the target modulation when the asymmetry value is sufficiently smaller than 0 and decreases the target modulation when the asymmetry value is sufficiently larger than 0.

According to another aspect, the present invention provides a method of optical recording performing an OPC operation with controlled laser power and recording information on a recording medium, including the steps of: measuring, in response to the OPC operation, reproduction information included in a signal reproduced from the recording medium; calculating an asymmetry value of the recording medium from the reproduction information; evaluating the asymmetry value, and determining target modulation of the OPC operation in accordance with the evaluation; changing the laser power in accordance with the determined target modulation; and overwriting the recording medium with the laser power attained when the asymmetry value comes close to 0.

Preferably, the step of determining the target modulation includes the steps of increasing the target modulation when the asymmetry value is sufficiently smaller than 0, and decreasing the target modulation when the asymmetry value is sufficiently larger than 0.

By the present invention, recording characteristic when the disc is overwritten can be improved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram schematically representing a configuration of an optical recording apparatus 10 in accordance with an embodiment of the present invention.

FIG. 2 shows waveforms of reproduced signals detected by a reproduction signal detecting circuit 31 of optical recording apparatus 10 shown in FIG. 1.

FIG. 3 shows reproduction information of an optical disc 1 as a background of optical recording apparatus 10 in accordance with an embodiment of the present invention.

FIG. 4 shows BLER after 100 times of overwriting on disc 1 having the asymmetry values calculated in accordance with FIG. 3.

FIG. 5 shows reproduction information of an optical disc 1 attained by optical recording apparatus 10 in accordance with an embodiment of the present invention.

FIG. 6 shows BLER after 100 times of overwriting on disc 1 having the asymmetry values calculated in accordance with FIG. 5.

FIG. 7 is a flow chart representing a method of evaluating an asymmetry value of optical recording apparatus 10 in accordance with an embodiment of the present invention.

### DESCRIPTION OF THE PREFERRED EMBODIMENTS

In the following, embodiments of the present invention will be described in detail with reference to the figures. Throughout the figures, the same or corresponding portions are denoted by the same reference characters and description thereof will not be repeated.

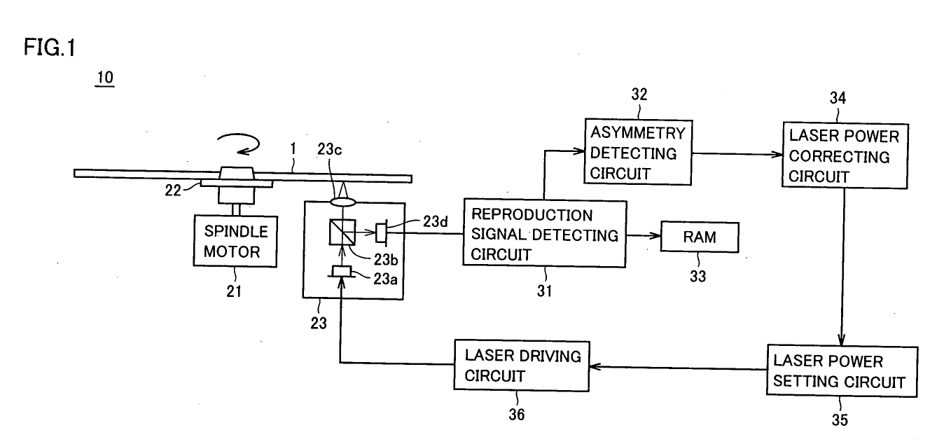

FIG. 1 is a block diagram schematically showing the configuration of an optical recording apparatus 10 in accordance with an embodiment of the present invention.

Referring to FIG. 1, optical recording apparatus 10 in accordance with the embodiment of the present invention includes a spindle motor 21, a turn table 22, an optical pick-up unit 23, a reproduction signal detecting circuit 31, an asymmetry detecting circuit 32, an RAM (Random Access Memory) 33, a laser power correcting circuit 34, a laser power setting circuit 35, and a laser driving circuit 36. Optical pick-up unit 23 includes a semiconductor laser 23a, a beam splitter 23b, an objective lens 23c and a photo detector 23d.

Optical recording apparatus 10 records information on a rewritable optical disc 1. Optical disc 1 is mounted on turntable 22 fixed on a shaft of spindle motor 21. A light beam emitted from semiconductor laser 23a is passed through beam splitter 23b, and collected by objective lens 23c onto optical disc 1. The light beam reflected from optical disc 1 is again passed through objective lens 23c, reflected by beam splitter 23b and received by photo detector 23d.

Reproduction signal detecting circuit 31 receives the signal output from photo detector 23d, and detects a reproduced signal. Asymmetry detecting circuit 32 detects an asymmetry value of optical disc 1, based on the reproduced signal. RAM 33 temporarily stores the reproduced signal. Laser power correcting circuit 34 calculates a laser power correcting value of semiconductor laser 23a, based on the asymmetry value of optical disc 1. Laser power setting circuit 35 sets the power of semiconductor laser 23a, in accordance with the power correcting value. Laser driving apparatus 36 drives the semiconductor laser 23a such that the output power thereof attains to the set value.

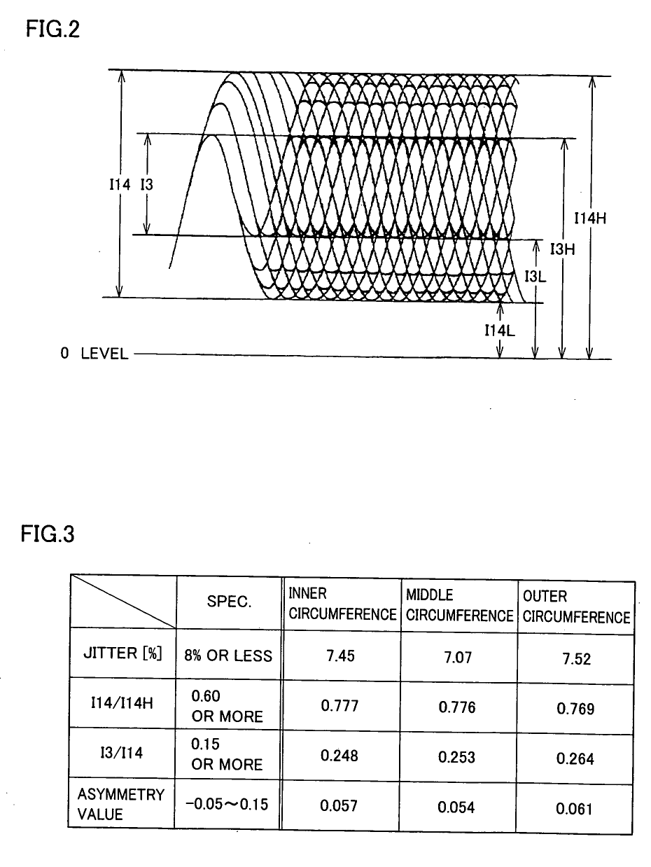

FIG. 2 shows waveforms of the reproduction signals detected by reproduction signal detecting circuit 31 of optical recording apparatus 10 shown in FIG. 1.

Referring to FIG. 2, “I14” represents amplitude (I14H-I14L) of the reproduction signal having the longest pattern, and “I3” represents amplitude (I3H-I3L) of the reproduction signal having the shortest pattern. Based on these values, the asymmetry value of optical disc 1 is calculated.

FIG. 3 shows reproduction information of optical disc 1 as the background of optical recording apparatus 10 in accordance with the embodiment of the present invention.

Referring to FIG. 3, optical recording apparatus 10 requires that the reproduction information of optical disc 1 satisfy the following specification: jitter of 8% or less, I14/I14H of 0.60 or more, and I3/I14 of 0.15 or more. Here, the jitter is 7.45%, 7.07% and 7.52%, respectively, at the inner, middle and outer circumference of the optical disc 1 shown in FIG. 3. The value I14/I14H is 0.777, 0.776 and 0.769, respectively, at the inner, middle and outer circumference of the optical disc 1 shown in FIG. 3. The value I3/I14 is 0.248, 0.253 and 0.264 respectively, at the inner, middle and outer circumference of the optical disc 1 shown in FIG. 3.

As described above, the jitter and I14/I14H and I3/I14 values at the inner, middle and outer circumference of optical disc 1 all satisfy the specification. The asymmetry value calculated from these measurements is required to satisfy the specification of −0.05 to 0.15. The asymmetry value of optical disc 1 is 0.057, 0.054 and 0.061, respectively, at the inner, middle and outer circumference, and satisfies the specification.

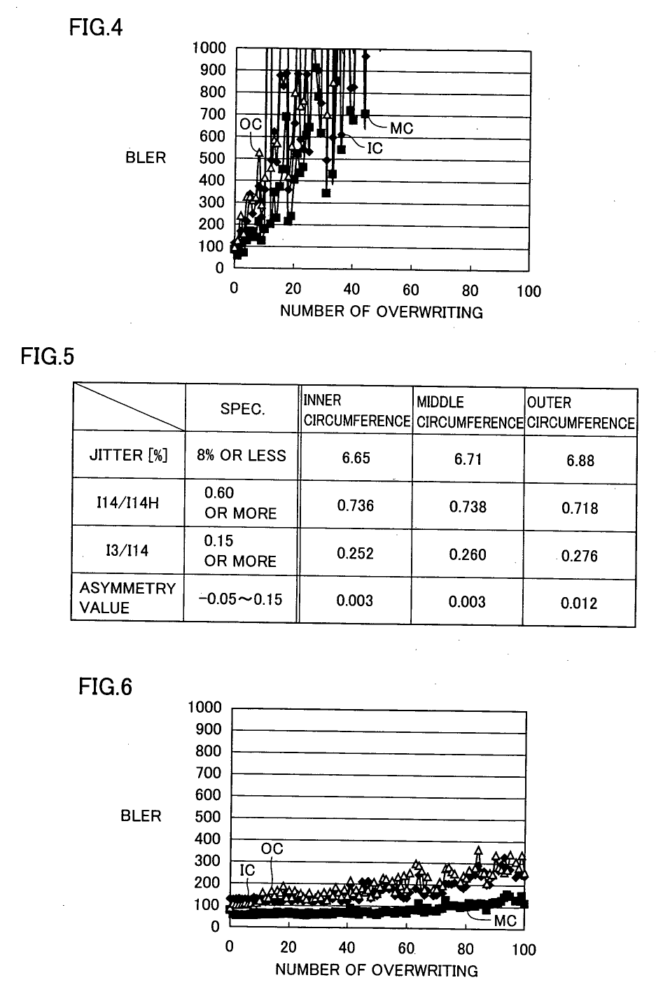

FIG. 4 shows BLER when optical disc 1 having the asymmetry values calculated in accordance with FIG. 3 is overwritten 100 times.

As can be seen from FIG. 4, as the number of overwriting (DOW: Direct Over Write) on optical disc 1 increases, the BLER values at the inner circumference (IC), middle circumference (MC) and outer circumference (OC) increase abruptly.

One possible reason why the BLER value increases abruptly as the number of overwriting of optical disc 1 increases may be that the asymmetry value of optical disc 1 is, though within the specification, far from the value 0. An embodiment in which the reproduction information of optical disc 1 is adjusted so that the asymmetry value 1 comes closer to 0 will be described in the following.

FIG. 5 represents the reproduction information of optical disc 1 of optical recording apparatus 10 in accordance with the embodiment of the present invention.

As shown in FIG. 5, the jitter of optical disc 1 here is 6.65%, 6.71% and 6.88%, respectively, at the inner, middle and outer circumference. The value I14/I14H of optical disc 1 is 0.736, 0.738 and 0.718, respectively, at the inner, middle and outer circumference. The value I3/I14 of optical disc 1 is 0.252, 0.260 and 0.276, respectively, at the inner, middle and outer circumference.

As described above, in FIG. 5, though the jitter and I14/I14H and I3/I14 values of optical disc 1 are different from those of FIG. 3, the values at the inner, middle and outer circumference all satisfy the specification. The asymmetry value calculated from these measurements is 0.003, 0.003 and 0.012, respectively, at the inner, middle and outer circumference, as shown in FIG. 5. Namely, the asymmetry values of optical disc 1 shown in FIG. 5 all satisfy the specification and closer to 0 than those of FIG. 3.

FIG. 6 shows BLER when optical disc 1 having the asymmetry values calculated in accordance with FIG. 5 is overwritten 100 times.

As can be seen from FIG. 6, even when the number of overwriting (DOW) on optical disc 1 increases, the BLER values at the inner circumference (IC), middle circumference (MC) and outer circumference (OC) increase only mildly, as compared with FIG. 4.

As described above, by adjusting the reproduction signal such that the asymmetry value of disc 1 comes closer to 0, increase in the BLER value can be suppressed even when the number of overwriting of optical disc 1 increases. The procedure for adjusting the asymmetry value closer to 0 to suppress the BLER value will be described in the following.

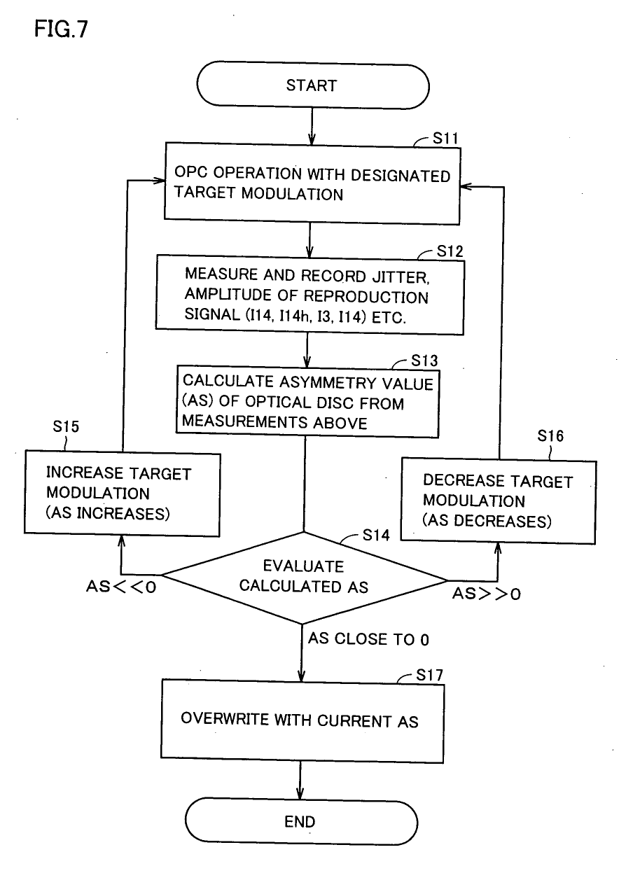

FIG. 7 is a flow chart representing a method of evaluating the asymmetry value of optical recording apparatus 10 in accordance with the embodiment of the present invention.

Referring to FIG. 7, optical recording apparatus 10 performs the OPC operation at a designated target modulation in step S11. In step S12, for the OPC operation, reproduction signal detecting circuit 31 measures pieces of reproduction information including jitter and amplitude of the reproduction signal (I14, I14H, I3, I14). RAM 33 temporarily stores the measured reproduction information. In step S13, asymmetry detecting circuit 32 calculates the asymmetry value AS of the optical disc from the measurements above. In step S14, laser power correcting circuit 34 evaluates the calculated asymmetry value AS.

If the asymmetry value is sufficiently smaller than 0 (AS<<0) in step S14, laser power correcting circuit 34 increases the target modulation in step S15, whereby the asymmetry value AS increases. Laser power setting circuit 35 adjusts the laser power in response to the increase of target modulation. Thereafter, the flow returns to step S11, and the OPC operation is again performed with the increased target modulation.

If the asymmetry value is sufficiently larger than 0 (AS>>0) in step S14, laser power correcting circuit 34 decreases the target modulation in step S16, whereby the asymmetry value AS decreases. Laser power setting circuit 35 adjusts the laser power in response to the decrease of target modulation. Thereafter, the flow returns to step S11, and the OPC operation is again performed with the decreased target modulation.

If the asymmetry value is close to 0 in step S14, laser power setting circuit 35 adjusts the laser power such that the current asymmetry value is maintained, in step S17. Laser driving circuit 36 performs the overwriting operation (DOW) with the current asymmetry value. Through the above-described steps, optical recording apparatus 10 can perform the overwriting operation with the asymmetry value adjusted to be close to 0. Thus, increase in the BLER value at the time of overwriting can be suppressed.

As described above, according to the embodiment of the present invention, by adjusting the reproduction information such that the asymmetry value of optical disc 1 comes closer to 0, increase in the BLER value in the overwriting operation can be suppressed. Thus, recording characteristic when the disc is overwritten can be improved.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An optical recording apparatus, performing an OPC operation with controlled laser power and recording information on a recording medium, comprising:
a reproduction signal detecting circuit measuring, in response to the OPC operation, reproduction information included in a signal reproduced from said recording medium;
an asymmetry detecting circuit calculating an asymmetry value of said recording medium from said reproduction information;
a laser power correcting circuit evaluating said asymmetry value and increasing target modulation when said asymmetry value is sufficiently smaller than 0 and decreasing said target modulation when said asymmetry value is sufficiently larger than 0;
a laser power setting circuit changing said laser power, in accordance with said target modulation determined by said laser power correcting circuit; and
a laser driving circuit performing an overwriting operation on said recording medium, with said laser power attained when said asymmetry value comes close to 0.

2. A method of optical recording performing an OPC operation with controlled laser power and recording information on a recording medium, comprising the steps of:
measuring, in response to the OPC operation, reproduction information included in a signal reproduced from said recording medium;
calculating an asymmetry value of said recording medium from said reproduction information;
evaluating said asymmetry value, increasing target modulation when said asymmetry value is sufficiently smaller than 0 and decreasing said target modulation when said asymmetry value is sufficiently larger than 0;
changing said laser power in accordance with said determined target modulation; and
overwriting said recording medium with said laser power attained when said asymmetry value comes close to 0.

3. An optical recording apparatus performing an OPC operation with controlled laser power and recording information on a recording medium, comprising:
a reproduction signal detecting circuit measuring, in response to the OPC operation, reproduction information included in a signal reproduced from said recording medium;
an asymmetry detecting circuit calculating an asymmetry value of said recording medium from said reproduction information;
a laser power correcting circuit evaluating said asymmetry value and determining target modulation of said OPC operation in accordance with the evaluation;
a laser power setting circuit changing said laser power, in accordance with said target modulation determined by said laser power correcting circuit; and
a laser driving circuit performing an overwriting operation on said recording medium, with said laser power attained when said asymmetry value comes close to 0.

4. The optical recording apparatus according to claim 3, wherein
said laser power correcting circuit increases the target modulation when said asymmetry value is sufficiently smaller than 0 and decreases said target modulation when said asymmetry value is sufficiently larger than 0.

5. A method of optical recording performing an OPC operation with controlled laser power and recording information on a recording medium, comprising the steps of:
measuring, in response to the OPC operation, reproduction information included in a signal reproduced from said recording medium;
calculating an asymmetry value of said recording medium from said reproduction information;
evaluating said asymmetry value, and determining target modulation of said OPC operation in accordance with the evaluation;
changing said laser power in accordance with said determined target modulation; and
overwriting said recording medium with said laser power attained when said asymmetry value comes close to 0.

6. The method of optical recording according to claim 5, wherein
said step of determining the target modulation includes the steps of
increasing the target modulation when said asymmetry value is sufficiently smaller than 0, and
decreasing said target modulation when said asymmetry value is sufficiently larger than 0.
